(19) United States
(12) Patent Application Publication
(10) Pub. No.: US 2018/0249824 A1
(43) Pub. Date: Sep. 6, 2018

(54) GLASS CERAMIC FURNITURE SURFACE

(71) Applicant: EUROKERA S.N.C., Chateau-Thierry (FR)

(72) Inventors: Gregory DEBREYER, Montcourt Fromonville (FR); Franck DEMOL, Reims (FR); Nicolas ROUX, Chateau-Thierry (FR); Pablo VILATO, Paris (FR)

(73) Assignee: EUROKERA S.N.C., Chateau-Thierry (FR)

(21) Appl. No.: 15/756,765

(22) PCT Filed: Sep. 6, 2016
(86) PCT No.: PCT/FR2016/052219

§ 371 Date: Mar. 1, 2018

(30) Foreign Application Priority Data
Sep. 8, 2015 (FR) 1558348

(51) Int. Cl. A47B 13/12; C03B 18/02; C03C 10/00

(52) U.S. Cl. CPC A47B 13/12; C03B 18/02; A47B 96/18; A47B 2220/008; C03C 10/0027

(57) ABSTRACT

A piece of furniture comprises at least one surface formed of at least one glass-ceramic monolithic substrate having a thickness of less than 15 mm, an expansion coefficient of less than 30×10⁻⁷ K⁻¹ between 20° C. and 400° C., and a surface area of greater than or equal to 0.1 m².

The present invention relates to the use of a glass-ceramic plate as a furniture surface, in particular a horizontal surface, this plate being in particular of large dimensions, and also relates to the furniture thus formed.

The materials normally used to produce pieces of furniture or surfaces of pieces of furniture are for example wood, plastic, quartz, Corian®, ceramic, sandstone, composite or multilayer materials, etc. The panels forming the surface of the pieces of furniture generally have a considerable thickness (about 2 to 5 cm for example) and may be more or less easy to maintain and be more or less durable. In the case of certain materials also, such as ceramic, they may also have a considerable weight, require specific cutting during manufacture, or recourse to joints that pose cleaning problems. Furthermore, some materials present risks of deterioration depending on their conditions of use (for example in the case of impacts or exposure to heat or to liquids).

The present invention has sought to widen the range of the existing furniture item products, for domestic or professional use, by developing products of a novel type advantageous for this purpose.

This objective has been achieved by the use of a glass-ceramic substrate, in particular a glass-ceramic plate (or sheet), having a thickness of less than 15 mm and an expansion coefficient of less than 30×10⁻⁷ K⁻¹ between 20° C. and 400° C. (and preferably of less than 13×10⁻⁷ K¹ between 20° C. and 400° C.), as a surface (in particular face) of a piece of furniture.

This objective has also been achieved by the novel piece of furniture according to the invention, this piece of furniture comprising at least one surface (generally upper and horizontal), in particular face, formed of at least one glass-ceramic monolithic (or monoblock or one-piece) substrate (in particular plate or table top or sheet), advantageously that is essentially flat, having a thickness of less than 15 mm, preferably of less than 12 mm, particularly preferably of less than or equal to 6 mm, and an expansion coefficient of less than 30×10⁻⁷ K¹ between 20° C. and 400° C. (and preferably of less than 13×10⁻⁷ K⁻¹ between 20° C. and 400° C.), and having a surface area (length by width of its face of larger dimensions) greater than or equal to 0.1 m², preferably of greater than 0.2 m², in particular greater than 0.4 m² and in particular greater than 0.7 m². Preferably, the glass-ceramic substrate also has one and/or other of the following characteristics (the limits given being included): Young's modulus of between 80 and 100 GPa (measured according to the ASTM C 1259 standard), flexural strength of between 110 and 220 MPa (measured by a ring-on-tripod test, on a 70 mm×70 mm×4 mm plate, the sample resting on three 9.5-mm diameter balls positioned at the vertex of an equilateral triangle inscribed in a 40-mm diameter circle, a force being applied to the center of the sample by a 10-mm diameter ring with an advance of 5 mm/min, the results being interpreted with the Weibull model described in: “A statistical distribution of strength of Materials”, Royal Swedish Institute For Engineering Research, W. Weibull, Stockholm 1939, 1-45, the data obtained, also referred to as a “scale factor”, revealing the average rupture stress resulting from the analysis by the Weibull method of the flexural modulus of rupture (MOR) measurements, being expressed in MPa), thermal conductivity of less than 2 W/m·K (measured according to the DIN 51936 standard), resistance to thermal shocks of between 250° C. and 700° C., density of between 2.3 and 2.7, resistance to acids of between 0 and 2 mg/cm² (measured according to the DIN12116 standard), and resistance to bases of between 0 and 1 mg/cm² (measured according to the ISO 695 standard).

The aforementioned glass-ceramic substrate may in particular be positioned horizontally or vertically on one or more support elements (carcass of a piece of furniture, support leg(s)) in order to offer a stable surface intended for various uses depending on the purpose of the piece of furniture. This piece of furniture may for example be a table or a worktop, a console table, a credenza, a laboratory table, a coffee table, a multipurpose cooking island, a piece of storage furniture, a cupboard door, a counter, etc.

The product developed according to the invention meets the desired objective, the present invention thus providing a novel item of equipment that can be used for various domestic or professional uses, it being possible for the glass-ceramic substrate to form part of a solid or apertured piece of furniture, and being in particular mounted horizontally on (in particular on the top of) one or more support elements (carcass of a piece of furniture, support leg(s)) in order to provide a stable surface intended for various uses, in particular a continuous upper surface suitable for simultaneously or successively allowing activities (such as work, games, reading, etc.), the support for objects (such as sheets of paper, computers, vases, dishes, etc.), optionally the preparation or cooking or reheating of food in appropriate containers, and/or any other use linked to the purpose of the piece of furniture.

As indicated according to the invention, at least one surface of the piece of furniture (generally the upper face) is formed from a glass-ceramic substrate, in particular of large dimensions (this substrate having been formed from a single block/as a single part, even though it may, if need be, contain voids, generally made in the part after it has been formed, for esthetic or functional reasons), the advantage of such a monolithic plate in particular being that it provides a predominantly continuous/uniform/join-free surface that is attractive, easy to maintain, and also more comfortable to use and safer (in respect of impermeability, in case of the spillage of liquids, etc.), etc. The substrate may, if need be, be equipped with thin decorative or functional coatings (in particular about a few tens of nanometers to a few hundred microns, or more in thickness), for example made of enamel, paint, thin layers, etc. as specified below.

Unlike the conventional use that is made of glass-ceramic type materials, which are conventionally used and designed to serve as cooktops or products intended to withstand high temperatures (such as fire guards), the glass-ceramic substrate is used here mainly for any other use/for a counter purpose/for an opposite use, even if incidentally it may still be used to heat containers, or keep them hot (if it is combined, optionally in an application where its main use is different, with heating elements), while nevertheless having various advantages that make it particularly suitable for this new application. Surprisingly, the use of a glass-ceramic surface as a single surface in various furniture uses is particularly advantageous (in particular in terms of maintenance, of durability irrespective of the usage conditions, and of resistance (possibility of placing containers that may be hot without however damaging the surface of the material of the worktop, and likewise in the case of the spillage of liquids, etc.). The fact of not generally having heating elements in these new applications furthermore constitutes an additional safety element that makes the use of the substrate safer (from the point of view in particular of the risks of burns), and that makes it possible, if need be, to more durably combine electronic or electrical components (displays, chips, lights, etc.) with the piece of furniture, it being possible for the glass-ceramic surface to further be combined with light sources to enable original light-emitting finishes or the projection of information depending on the composition of said glass-ceramic.

Customarily, the cooktops made of glass-ceramic type materials are of limited dimensions, plates of large surface area possibly being difficult to obtain by the processes customarily used, and possibly posing problems in terms of flatness, handling, etc. The glass-ceramic substrate used according to the invention may advantageously be of large dimensions, its surface area (corresponding to the product of its length and its width for its face of larger dimensions—generally its upper face), intended to be visible and to serve as support for articles, possibly advantageously having dimensions of greater than 0.7 m², in particular greater than 0.9 m², in particular greater than 1 m², or even greater than or equal to 2 m² (for worktops, laboratory tables, kitchen or dining room tables or islands, etc). Despite the manufacture of large plates posing numerous problems in terms of flatness and handling in the case of glass-ceramic, plates of large dimensions, yet having a good flatness, have nevertheless been able to be obtained by two different processes according to the invention.

In a first advantageous embodiment, the plates of large dimensions (greater than 0.4 m², and in particular greater than 0.7 m²) were able to be obtained by reducing the speed of travel (or lengthening the ceramization kiln or increasing the residence time in the kiln), relative to the speed (or to the standard length of the kiln or to the standard time) normally used to obtain glass-ceramic plates of normal dimensions of less than 0.4 m², as explained subsequently in a process according to the invention.

In a second particularly advantageous embodiment, the plates of large dimensions were able to be obtained by the float process, as explained subsequently in another process according to the invention.

In the present invention, the glass-ceramic substrate thus advantageously forms the major part (at least 50%), or even all, of the surface area of (at least) one face of a piece of furniture. in particular, the glass-ceramic substrate advantageously occupies, in the present invention, at least 50%, in particular at least 70%, in particular at least 90%, of said surface area, and it generally occupies all of said surface area, the surface area being understood as the solid surface area (surface area occupied, excluding that/those surface area(s) occupied by possible voids (such as a void in the piece of furniture for incorporating a sink)) on the face of the piece of furniture under consideration (generally its upper face (in the position of use), intended to be visible and to act as support for articles), or even being understood in particular as the overall surface area corresponding to the product of the length of said face and its width).

Advantageously, the glass-ceramic substrate forms at least 50%, in particular at least 70%, in particular at least 90%, or even all, of a face of the piece of furniture, or in other words, a face of the piece of furniture (generally the upper face of the piece of furniture) is mainly (to at least 50%, in particular at least 70%, in particular at least 90%), in particular entirely (or solely), formed of the (or constituted by the, or consists of the) aforementioned glass-ceramic substrate.

The substrate according to the invention is advantageously flat (or predominantly or virtually flat) and in particular has a flatness (height between the highest point and the lowest point of the substrate, with respect to the mean plane of the substrate, excluding any possible deliberate deformations produced on the substrate for esthetic or functional purposes) of less than 0.1% of the diagonal of the substrate, and preferably of less than 3 mm, in particular of less than 2 mm and in particular of less than 1 mm, or even of about zero, depending on the size/surface area/diagonal of the substrate, the flatness being measured using a SurFlat waviness meter sold by Visuol. The substrate is generally of geometric shape, in particular rectangular, square, circular or oval, etc. shape, and generally has an “upper” face (face which is visible) in the position of use, another “lower” face (generally hidden, in the framework or carcass of the piece of furniture incorporating the worktop) in the position of use, and an edge face (or edge or thickness). The upper face is generally flat and smooth but may also have at least one raised zone and/or at least one recessed zone and/or at least one opening and/or beveled edges (these shapes having, where appropriate, been added during the manufacture of the substrate, for example by rolling or sag bending or pressing, etc., or having been added in off-line operations), etc., these variations in shape advantageously constituting continuous variations in the plate (without change in materials or joins). The lower face can in particular be smooth or provided with studs increasing its mechanical strength and obtained, for example, by rolling.

According to one embodiment of the invention, the glass-ceramic substrate is advantageously structured (has one or more raised and/or recessed zones, in particular that are regularly spaced), these variations in shape constituting in particular continuous variations of the substrate and making it possible to confer supplementary properties (in particular optical and/or mechanical properties) on the substrate.

The thickness of the glass-ceramic substrate is generally at least 2 mm, in particular at least 3 mm, and in particular is about 3 to 15 mm, and advantageously is less than 12 mm, and particularly preferably less than or equal to 6 mm, in particular is about 3 to 6 mm.

The glass-ceramic further advantageously has, as defined according to the invention, an expansion coefficient of less than 30×10⁻⁷ K⁻¹ between 20° C. and 400° C., and preferably of less than 13×10⁻⁷ K⁻¹ between 20° C. and 400° C., and particularly preferably an expansion coefficient of less than or equal to 10×10⁻⁷ K⁻¹ between 20° C. and 400° C.

Various types of glass-ceramic plates may be used depending on the purpose of the piece of furniture and the desired effects. The glass-ceramic chosen is in particular and advantageously a lithium aluminosilicate glass-ceramic.

In one embodiment, the substrate/the glass-ceramic may in particular be chosen advantageously to be weakly transmissive, weakly scattering and of dark color (in particular of low lightness L*), in particular of black or dark brown color, this material enabling in particular a display by light transmission through the substrate while masking the inside of the piece of furniture, as explained subsequently. This glass-ceramic may in particular have a composition as described in the patent applications published under the following numbers: WO2012156444, WO2012001300, DE202012011811.

For example, use is advantageously made of a glass-ceramic comprising the following constituents and/or obtained by ceramization using a glass having the following composition, within the limits below expressed as percentages by weight: SiO₂: 52-75%; Al₂O₃: 18-27%; Li₂O: 2.5-5.5%; K₂O: 0-3%; Na₂O: 0-3%; ZnO: 0-3.5%; MgO: 0-3%; CaO: 0-2.5%; BaO: 0-3.5%; SrO: 0-2%; TiO₂: 1.2-5.5%; ZrO₂: 0-3%; and P₂O₅: 0-8%; and preferably within the limits below expressed as percentages by weight: SiO₂: 64-70%; Al₂O₃: 18-21%; Li₂O: 2.5-3.9%; K₂O: 0-1.0%; Na₂O: 0-1.0%; ZnO: 1.2-2.8%; MgO: 0.20-1.5%; CaO: 0-1%; BaO: 0-3%; SrO: 0-1.4%; TiO₂: 1.8-3.2%; and ZrO₂: 1.0-2.5%.

This glass-ceramic may in particular have the following characteristics: a lightness L* of less than 10, a haze of less than 30%, and a light transmission T_{L} of less than 10% in order for example to hide the underlying elements of the piece of furniture, while enabling, for example, a light display or display of information by underlying light sources, as explained subsequently.

In another embodiment, the substrate/glass-ceramic may advantageously be opaque and/or weakly transmissive while being scattering and sufficiently light (in particular of sufficient lightness L*), the glass-ceramic possibly being bulk-tinted or colored (this coloration including white and all colors having a lightness L* of greater than 10, with the exception of dark colors such as black or dark brown) in order to offer a range of various colors for use in the piece of furniture, this opaque but light and/or colored glass-ceramic also making it possible to mask the inside of the piece of furniture while offering a suitable surface, where appropriate, for displaying data by projection onto the substrate as explained subsequently.

This glass-ceramic may in particular have a composition as described in the patent applications published under the following numbers: EP1300372, U.S. Pat. No. 6,706,653, WO9906334, WO2007113242, EP1840093, US2007213192, U.S. Pat. No. 7,476,633, JP2009531261, WO2012156444, WO2012001300, DE202012011811, this glass-ceramic also comprising, where appropriate, colorants.

For example, use is advantageously made of a glass-ceramic comprising the following constituents and/or obtained by ceramization using a glass having the following composition, within the limits below expressed as percentages by weight: SiO₂: 52-75%; Al₂O₃: 18-27%; Li₂O: 2.5-5.5%; K₂O: 0-3%; Na₂O: 0-3%; ZnO: 0-4%; MgO: 0-5%; CaO: 0-2.5%; BaO: 0-3.5%; SrO: 0-2%; TiO₂: 0-5.5%; ZrO₂: 0-3%; and P₂O₅: 0-8%, B₂O₃: 0-5%; and preferably within the limits below expressed as percentages by weight: SiO₂: 55-70%; Al₂O₃: 18-24%; Li₂O: 2.5-4.5%; K₂O: 0-2.0%; Na₂O: 0-2.0%; ZnO: 1.5-4%; MgO: 0.20-5%; CaO: 0-1%; BaO: 0-3%; SrO: 0-1.4%; TiO₂: 1.8-5%; ZrO₂: 0-2.5%; P₂O₅: 0-8%; and B₂O₃: 0-5%, this composition also comprising, where appropriate, supplementary colorants.

This glass-ceramic may also advantageously have the following characteristics: a lightness L* of greater than 10, a light transmission T_{L} of less than 60%, an opacity indicator of greater than 30, and where appropriate a haze of greater than 15% in order to mask in particular the inside of the piece of furniture while enabling the projection of information or decorations on its surface as explained subsequently.

In another embodiment, the substrate/glass-ceramic may advantageously be transparent, in particular may have a light transmission T_{L} of greater than 10%, in particular greater than 60%, or even greater than 80%, and an opacity indicator of between 5 and 90, said substrate possibly being (predominantly or even entirely) bare (not coated or provided with coating(s) on a limited part of its surface, in particular on less than 10% of its surface), for example in the case where vision through the substrate is desired, or else provided with coating(s) or combined with an added element (also mounted in the piece of furniture, optionally in contact with the glass-ceramic), it being possible for the substrate thus coated or combined in particular to have a haze of greater than 15%, a light transmission T_{L} of less than 80%, and an opacity indicator of greater than 50, in order in particular to mask the inside of the piece of furniture while enabling, for example, the projection of information or decorations on its surface as explained subsequently.

This transparent glass-ceramic may in particular have a composition as described in the patent applications published under the following numbers: WO2013171288, US2010167903, WO2008065166, EP2086895, JP2010510951, EP2086896, WO2008065167, US2010099546, JP2010510952, EP0437228.

The glass-ceramic may be refined with arsenic (that is to say, have (a mother glass with) a composition comprising about 0.5% to 1.5% by weight of arsenic oxide (expressed as As₂O₃)) or may not be refined with arsenic (in particular having a content of arsenic oxides of less than 0.2%, in particular of less than 0.1%, or even zero) or refined with tin or refined with sulfide(s), and may be obtained by rolling or by the float process.

The glass-ceramic is obtained for example by the respective processes described in the aforementioned documents, by modifying said processes if need be (in particular to form large plates), by reducing the speed of travel through the ceramization kiln by at least 25%, preferably by at least 50%, or by increasing the length of the ceramization kiln or the residence time in said kiln by at least 25%, preferably by at least 50%, relative, respectively, to the speeds, lengths and times normally used, in order to obtain a flat substrate of large dimensions.

Alternatively, the glass-ceramic may advantageously be obtained by the float process, in particular by manufacturing the flat ribbon of precursor glass for a glass-ceramic by continuous floating of the molten glass on a bath of molten metal in a float chamber, said glass being poured in the molten state and at a temperature above its devitrification onset temperature onto the molten metal upstream of the chamber, and gradually forming a ribbon that runs along said metal bath. The glass obtained is then ceramized in a manner known per se (as explained subsequently). This process advantageously makes it possible to obtain large glass-ceramic plates that have good flatness as desired according to the invention.

In this process, the cooling rate of the glass is preferably at least 18° C./min between the moment when the glass is at the theoretical temperature for which the devitrification rate is a maximum, and the moment when the glass is at the theoretical temperature at which the devitrification crystal growth rate becomes less than 1 micrometer per minute, as explained in particular in patent application WO 2008/056080.

As indicated above, the substrate/glass-ceramic may be chosen so as to have, in particular, specific optical characteristics such as a lightness L*, a haze H, a light transmission T_{L}, and/or an opacity indicator Ω. The substrate has, where appropriate, these characteristics over most (in particular over at least 80% or even over 100%) of its surface area, excluding any possible localized decorations (for example made of enamel) or localized components applied to its surface. These properties are generally those of the glass-ceramic forming the substrate itself, without the presence of any coating, but where appropriate may result from the combination of the glass-ceramic and a coating applied to most of one and/or other of its main faces and/or combined with said glass-ceramic.

The lightness L* is a component defined in the CIE colorimetric system and is evaluated in a known way, in particular using a Byk-Gardner Color Guide 45/0 colorimeter (colorimetry in reflection) on the upper face of the substrate placed on an opaque white background.

The haze measures the level of light scattering and is defined, in the context of the invention, as being the ratio of the diffuse transmission to the total transmission (in the visible region), this haze being evaluated, for example, using the spectrophotometer equipped with an integrating sphere and used for the light transmission measurements.

The light transmission T_{L} is measured according to the standard ISO 9050:2003 using the illuminant D65 and is the total transmission (integrated in the visible region), taking into account both direct transmission and possible diffuse transmission, the measurement being carried out, for example, using a spectrophotometer equipped with an integrating sphere, the measurement at a given thickness subsequently being converted, if appropriate, to the reference thickness of 4 mm according to the standard ISO 9050:2003.

The opacity indicator Ω in the present invention is determined by the formula Ω=100−ΔE* and is evaluated by measuring (colorimetry in reflection carried out using a Byk-Gardner Color Guide 45/0 colorimeter) the variation in color ΔE*, corresponding to the difference between the color, measured in reflection on the upper face of the substrate, for the substrate placed on an opaque black background and the color for the substrate placed on an opaque white background (ΔE*=((L_{B}*−L_{W}*)²+(a_{B}*−a_{W}*)²+(b_{B}*−b_{W}*)²)^{1/2}, L_{W}*, a_{W}* and b_{B}* being the colorimetric coordinates of the first measurement on the white background and L_{B}*, a_{B}* and b_{B}* being those of the second measurement on the black background in the colorimetric system established by the CIE in 1976.

In a first embodiment mentioned above, the glass-ceramic is in particular dark in appearance, and is formed from a weakly transmissive and weakly scattering material, and in particular is black or brown in appearance, in particular making it possible, in combination with light sources placed underneath, to display lighting effects or to display data, while masking the underlying elements of the piece of furniture. The glass-ceramic also preferentially has, in this case, an opacity indicator (or factor or coefficient) Ω of less than 100, and advantageously of greater than 93, in order in particular to enable said display by underlying sources or even by projection as indicated subsequently.

It is for example a black glass-ceramic generally comprising crystals of β-quartz structure within a residual glassy phase, such as the glass-ceramic of the plates sold under the name Kerablack+ by Eurokera. In particular, it may be a glass-ceramic refined with arsenic having a composition as described in patent application EP0437228, U.S. Pat. No. 5,070,045 or FR2657079, or a glass-ceramic refined with tin, having a content of arsenic oxides of less than 0.2% (or even of less than 0.1%, or even of less than or equal to 500 ppm, or even of zero), for example having a composition as described in the patent application WO 2012/156444, or else refined with sulfide(s) as described in patent application WO2008053110.

In a second embodiment mentioned above, the glass-ceramic is in particular of relatively light and scattering opaque (and/or weakly transmissive) colored appearance, in particular is bulk-tinted or colored, this coloration including white and all colors having a lightness L* of greater than 10, the darker colors such as black or dark brown being excluded, this material enabling, inter alia, a display by projection, in particular making it possible, in combination with light sources placed above, to display luminous zones or decorations, this material simultaneously masking the optional elements placed underneath. Advantageously, the glass material forming the substrate is translucent or opaque (in particular it has a light transmission T_{L} of less than 60%, in particular of less than 50%); it may in particular be translucent or opaque and white, cream, or even gray or violet in color, or another color.

In this embodiment, the substrate is in particular advantageously based on a translucent or opaque white or cream glass-ceramic generally comprising crystals of β-spodumene structure within a residual glassy phase, such as the glass-ceramic of the plates sold under the name Kerawhite, KeraWhite TC or Kerabiscuit by Eurokera.

In a third embodiment mentioned above, the glass-ceramic is in particular transparent and generally comprises crystals of β-quartz structure within a residual glassy phase, this glass-ceramic being for example that of the plates sold under the name KeraLite by Eurokera.

The substrate/glass-ceramic may, where appropriate, comprise colorants that give particular colorations or shades or tints (for example violet, green, gray, etc.), in amounts preferably of less than 10% by weight, for example of vanadium oxide, iron oxide, cobalt oxide, cerium oxide, selenium oxide, chromium oxide or even nickel oxide, copper oxide and/or manganese oxide, etc.

Alternatively or conjointly, the substrate/glass-ceramic may also be provided with a coating that gives it, where appropriate, a different coloration from its own coloration, for example it may be provided with at least one layer of paint on at least one part or most or all of one of its main faces (in particular the lower face), for example at least one layer of paint of pistachio, gray, blue, yellow or red color, etc. Other coatings may also be used (for this purpose or for other purposes, for example for decorative patterns), for example enamel, thin layers, etc. The coating may also act as masking means intended to mask at least some of the underlying elements, and where appropriate making it possible to impart an opacity/weak transmission and/or a haze suitable for the display by light transmission through the substrate or for the display by light projection at the surface of the substrate forming a screen.

An example of a substrate equipped with an opacifying or coloring coating is for example a plate sold under the name KeraResin by Eurokera.

As mentioned above, the substrate/glass-ceramic may also or alternatively be coupled to an added element, it being possible for this added element to act for example as reinforcement, or as masking means and/or to make it possible to impart an opacity/weak transmission and/or a haze suitable for the display by light transmission through the substrate or for the display by light projection at the surface of the substrate forming a screen, etc. The term “coupled” is understood to mean that the element modifies the characteristics, for example optical or strength characteristics, of the substrate for the use thereof in the piece of furniture according to the invention. The term “added” is understood to mean manufactured separately from the substrate (unlike a coating obtained by direct deposition on the substrate), this element possibly then being combined with the substrate by adhesive bonding, welding, lamination, calendering, fixing to the same frame or to the same framework, it being possible for the added element to be placed against the substrate or at a distance (where appropriate using spacers, etc.), the added element advantageously being coupled to the substrate while being under the latter (in the position of use). The thickness of the added element may in particular be from 0.1 to 100 mm.

In one advantageous embodiment, the glass-ceramic substrate is thus coupled to a second substrate, that is in particular (essentially) flat, in order to reinforce the glass-ceramic when the latter is thin (in particular having a thickness of less than or equal to 6 mm) and/or in order to give the impression of a heavy and solid surface without however making the weight at the surface heavy. This second substrate may for example be at least one particleboard, wooden panel, one or more plastic (for example PVB—polyvinyl butyral—or polycarbonate or bakelite, etc.) or cardboard sheets, a honeycomb structure, etc.

The added element may also be a slab or sheet of mica, of plywood, of laminate, of glass, of stone, etc. for masking purposes in particular, etc.

In one embodiment of the invention, the piece of furniture might also comprise at least one light source, for example for light effects or for displaying data, this source possibly being under the substrate and being hidden thereby when this source is turned off or else possibly being directly above the substrate, for display or lighting by projection.

The light source(s) where appropriate present may enable the display of data, or the lighting of zones, and may be able to be activated where appropriate by controls integrated into the piece of furniture or by contact on the surface of the piece of furniture or remotely (in particular by wireless communication), or even by simple movement of the hand, or where appropriate by placing a given object on a given location of the piece of furniture or of the glass-ceramic substrate. The light source(s) may in particular enable the display of decorations, or of various data (for example computer pages, operating processes, a directory, etc.) downloaded, for example, by wireless communication using an appropriate interface and projected or transmitted from the light sources to the surface of the substrate/piece of furniture, for example for pieces of furniture of the following type: worktop, kitchen or dining room island, laboratory table, etc.

In one embodiment of the invention, the piece of furniture may also comprise, if need be, at least one heating element, for example located under the substrate and hidden where appropriate thereby when turned off.

In one embodiment of the invention, the piece of furniture may also comprise at least one interface for communication with at least one element of the piece of furniture such as one or more light sources and/or one or more heating elements, and/or where appropriate with at least one external element for wireless communication, it being possible for the piece of furniture thus equipped to advantageously be interactive.

The glass-ceramic substrate, as already mentioned, may also comprise various functional and/or decorative coatings, in particular from among those generally used with glass-ceramics, for example coatings based on enamel, on paint, on thin (for example metal, dielectric, etc.) layer(s), etc. For example, one of the faces of the substrate may comprise one or more enamel layers or one or more enamel patterns having a decorative purpose and/or in order to signal one or more elements and/or acting as masking and/or for other functions (as light extractor or to render the illumination uniform, etc.). In particular, the glass-ceramic substrate may be provided with a functional layer that gives it one or more supplementary properties such as scratch resistant, mechanical strengthening, anti-smudge or anti-fingerprint, anti-overflow, etc. properties. The coating may be produced for example by processes such as screenprinting, cathode sputtering or pneumatic spraying deposition, inkjet printing, enamel jet printing, etc., it being possible for the coating to be applied in particular, depending on the type of coating and on the desired function, to the visible face or to the opposite face. For example, in the case of an enamel decoration, the enamel is preferentially deposited on the upper face in particular for reasons of visibility, whereas an opacifying layer of paint is preferentially deposited on the opposite face, which is not visible, in particular for better protection against abrasion, etc.

As indicated above, the decorations (or at least a portion of them) or displays may also advantageously be obtained by a light display (rather than by deposition of a coating), or even by light projection, as already mentioned above.

The present invention also relates to a first process for manufacturing a piece of furniture according to the invention, in particular the glass-ceramic substrate equipping it or intended to equip it, in which at least one cycle of ceramization of a glass plate is carried out in order to obtain said substrate, and according to which the speed of travel is reduced by at least 25%, preferably by at least 50%, or the length of the ceramization kiln or the residence time in said kiln is increased by at least 25%, preferably at least 50%, relative, respectively, to the standard speed, length or residence time for obtaining a glass-ceramic substrate intended to form a customary cooktop.

The present invention also relates to a second advantageous process for manufacturing a piece of furniture according to the invention, in particular the glass-ceramic substrate equipping it or intended to equip it, wherein the flat ribbon of precursor glass for a glass-ceramic is manufactured by continuous floating of the molten glass on a bath of molten metal in a float chamber, said glass being poured in the molten state and at a temperature above its devitrification onset temperature onto the molten metal upstream of the chamber, and gradually forming a ribbon that runs along said metal bath.

For the record, glass-ceramic plates are generally manufactured as follows: glass with the composition chosen for forming the glass-ceramic is melted in a melting furnace, the molten glass is then rolled to give a standard ribbon or sheet by passing the molten glass between forming rollers, and the glass ribbon is cut to the desired dimensions. Alternatively to the rolling, the glass can be floated, as described, for example, in patent application WO 2008/056080, before, if appropriate, being cut up. The plates, already or not yet cut up, are subsequently ceramized in a manner known per se, the ceramization consisting in firing the plates according to the temperature profile chosen in order to convert the glass into the polycrystalline material referred to as “glass-ceramic”, the expansion coefficient of which is zero or virtually zero and which withstands a thermal shock which can range up to 700° C. The ceramization generally comprises a step of gradual rise in the temperature up to the nucleation range, generally located in the vicinity of the range for transformation of the glass; a step, lasting several minutes, of passing through the nucleation range; a new gradual rise in the temperature up to the ceramization hold temperature; maintaining the ceramization hold temperature for several minutes; and then a rapid cooling down to ambient temperature. If appropriate, the process also comprises a cutting operation (generally before ceramization), for example with a water jet, mechanical scoring with a cutting wheel, etc., followed by a shaping operation (grinding, beveling, etc.). The process can also comprise a step of rolling or sag bending in order to form specific protrusions.

Other advantageous characteristics and details will emerge below from the description of two nonlimiting embodiments of the invention.

In the first example, the piece of furniture is a worktop or a credenza formed from a carcass surmounted (solely) by a glass-ceramic monolithic substrate having a surface area of 1.6 m², or a coffee table having a surface area of 0.96 m², or a cupboard door, formed from a glass-ceramic monolithic substrate of suitable dimensions. The glass-ceramic monolithic substrate is for example a plate of the same type as those sold under the reference KeraBlack+ by Eurokera, this plate having a smooth upper face and a lower face provided with studs, and a thickness of 6 mm, and having an expansion coefficient of less than 0.7×10⁻⁷ K⁻¹ between 20° C. and 400° C., a lightness L* of 0.17, a haze of 0.7%, a light transmission T_{L} of 1.2% and an opacity indicator of 99.4. This substrate also has the following characteristics: Young's modulus of 93.7 GPa, flexural strength of 198 MPa, thermal conductivity of 1.46 W/m·K, resistance to thermal shocks of 700° C., density of 2.54, resistance to acids of 0.014 mg/cm², and resistance to bases of 0.406 mg/cm². This substrate is for example obtained by proceeding in the way described in patent application WO2012156444 but while decreasing the run speed through the ceramization kiln by 50%, or by the float process.

The substrate obtained has a black color and has a flatness of less than 2 mm.

In the second example, the piece of furniture is a console table formed of a central leg and surmounted (solely) by a light transparent or translucent glass-ceramic monolithic substrate having a surface area of 1.2 m². This substrate is for example a plate of the same type as those sold under the reference KeraLite by Eurokera or a plate sold under the reference KeraWhite by Eurokera, this plate having for example a smooth upper face and a smooth lower face, and a thickness of 5 mm, and having an expansion coefficient of 10×10⁻⁷ K⁻¹ between 20° C. and 400° C., a light transmission T_{L} of 87.8%, a haze of 0.6% and an opacity indicator of 26.7. This substrate also has the following characteristics: Young's modulus of 84.1 GPa, flexural strength of 166 MPa, thermal conductivity of 1.6 W/m·K and resistance to thermal shocks of 650° C. This substrate is for example obtained by reducing, in the process for manufacturing glass-ceramics of KeraLite type, the run speed through the ceramization kiln by 50%.

The substrate obtained is transparent and has a flatness of less than 2 mm.

The equipment according to the invention may in particular be used advantageously to produce a new range of furniture.

1. A piece of furniture comprising:
at least one surface formed of at least one glass-ceramic monolithic substrate having a thickness of less than 15 mm, an expansion coefficient of less than 30×10⁻⁷ K⁻¹ between 20° C. and 400° C., and a surface area of greater than or equal to 0.1 m².

2. The piece of furniture as claimed in claim 1, wherein the glass-ceramic substrate also has at least one of the following characteristics: Young's modulus of between 80 and 100 GPa, flexural strength of between 110 and 220 MPa, thermal conductivity of less than 2 W/m·K, resistance to thermal shocks of between 250° C. and 700° C., density of between 2.3 and 2.7, resistance to acids of between 0 and 2 mg/cm², and resistance to bases of between 0 and 1 mg/cm².

3. The piece of furniture as claimed in claim 1, wherein the surface area of the glass-ceramic substrate is greater than 0.2 m², the thickness of said substrate is at least 2 mm the glass-ceramic substrate further having an expansion coefficient of less than 13.10⁻⁷K⁻¹ between 20° C. and 400° C.

4. The piece of furniture as claimed in claim 1, wherein said glass-ceramic substrate occupies at least 50% of the surface area of a face of the piece of furniture.

5. The piece of furniture as claimed in claim 1, wherein the glass-ceramic substrate has a flatness of less than 0.1% of the diagonal of the glass-ceramic substrate.

6. The piece of furniture as claimed in claim 1, wherein the glass-ceramic substrate is structured.

7. The piece of furniture as claimed in claim 1, wherein the glass-ceramic substrate is coupled to a second substrate, the second substrate being at least one particleboard, wooden panel, one or more plastic or cardboard sheets, a honeycomb structure, a sheet of mica, of plywood, of laminate, of glass or of stone.

8. The piece of furniture as claimed in claim 1, wherein the glass-ceramic substrate is dark in appearance and has a lightness L* of less than 10, a haze of less than 30%, and a light transmission T_{L} of less than 10%.

9. The piece of furniture as claimed in claim 1, wherein the glass-ceramic substrate is light in appearance and has a light transmission T_{L} of less than 60%, an opacity indicator of greater than 30, and a haze of greater than 15%.

10. The piece of furniture as claimed in claim 1, wherein the glass-ceramic substrate is transparent, and has a light transmission T_{L} of greater than 10% and an opacity indicator of between 5 and 90.

11. The piece of furniture as claimed in claim 1, further comprising at least one light source and/or at least one heating element and/or at least one interface for communication with at least one element of the piece of furniture and/or with at least one external element for wireless communication.

12. The piece of furniture as claimed in claim 1, wherein the glass-ceramic substrate comprises one or more functional and/or decorative coatings.

13. The piece of furniture as claimed in claim 1, wherein the glass-ceramic substrate is mounted on at least one or more support elements, and thus forms with said support elements a table or a worktop, a console table, a credenza, a laboratory table, a coffee table, a multipurpose cooking island, a piece of storage furniture, a cupboard door or a counter.

14. A method, comprising:
obtaining a glass-ceramic substrate having a thickness of less than 15 mm and an expansion coefficient of less than 30×10⁻⁷ K⁻¹ between 20° C. and 400° C.; and
using the glass-ceramic substrate as a surface of a piece of furniture.

15. A surface of a piece of furniture, comprising:
at least one glass-ceramic monolithic substrate having a thickness of less than 15 mm, an expansion coefficient of less than 30×10⁻⁷ K⁻¹ between 20° C. and 400° C., and a surface area of greater than or equal to 0.1 m².

16. A process for manufacturing the piece of furniture as claimed in claim 1, comprising:
manufacturing a flat ribbon of precursor glass for the glass-ceramic substrate by continuous floating of the molten glass on a bath of molten metal in a float chamber, said glass being poured in the molten state and at a temperature above its devitrification onset temperature onto the molten metal upstream of the chamber; and
gradually forming a ribbon that runs along said metal bath.

17. The piece of furniture as claimed in claim 3, wherein the thickness of said glass-ceramic substrate is 3 to 15 mm.

18. The piece of furniture as claimed in claim 5, wherein the flatness of the glass-ceramic substrate is less than 3 mm.

19. The piece of furniture as claimed in claim 8, wherein the glass-ceramic substrate is black or brown.

20. The piece of furniture as claimed in claim 13, wherein the support element is a carcass or one or more support legs.
